(19) United States
(12) Patent Application Publication
(10) Pub. No.: US 2013/0098781 A1
(43) Pub. Date: Apr. 25, 2013

(54) Jewelry Hanger Card and Method of Assembling The Same

(71) Applicant: Teresa P. Galan, Mineola, NY (US)

(72) Inventor: Teresa P. Galan, Mineola, NY (US)

(73) Assignee: Jacmel Jewelry Inc., Long Island City, NY (US)

(21) Appl. No.: 13/276,946

(22) Filed: Oct. 19, 2011

(51) Int. Cl. A45C 11/00; B65B 1/04; B31B 1/14; B65D 73/00

(52) U.S. Cl. 206/6.1; 206/476; 53/473; 53/467; 493/56

(57) ABSTRACT

A jewelry hanger card includes a body, a neck, a jewelry holder and a pair of supports. The body, the jewelry holder and the pair of supports are individually and foldably connected to the neck at respective fold lines. During assembly, each fold line is folded approximately 90 degrees with respect to the neck and a J-clip is adhered to a back surface of the body so that the jewelry hanger card may form a jewelry hanger for a display case. A pair of earring are then attached to the earring holder and the earring hanger is then placed on a jewelry rack for display.

### FIELD

The present invention is directed towards a jewelry hanger card. Specifically, a jewelry hanger card that may be manufactured and shipped flat and then foldably assembled into a jewelry hanger for display in a jewelry display case.

### BACKGROUND

In the jewelry industry, it is advantageous for marketing purposes to display jewelry in a fashion that is aesthetically pleasing. For a large part jewelry is displayed in some type of display case. One type of jewelry display case is a J-channel display. The J-channel is commonly used with jewelry display cards for displaying various types of jewelry items, including earrings, pendants, and pins. As shown in FIG. 9, the jewelry display card 90 is usually constructed from plastic and has a substantially flat planar card portion 92 and a J-clip hanger portion 94 which extends integrally rearwardly from the upper extremity of the card portion 92 for suspending the card 90 from a J-channel 96 on a display rack (not shown). The card portion 92 of a display card has a pair of dog ears 98a-b that extend outwards from the card portion 92 and include apertures 100a-b for securing jewelry items 102 thereon with fastening elements 104a-b, such as the pins or posts of the jewelry items. In some cases, the card portion 92 may have a decorative fabric or the like on the front side thereof for providing a background for the jewelry items.

While display cards of the above described type have been found to be effective for both packaging and displaying jewelry items, it has been found that when displaying hoop earrings on these displays, the hoop earrings tend to overlap and scratch one another. Also, when displaying hoop earrings on a display rack, the display cards must be placed a certain distance from one another so that the hoop earrings do not interfere with each other. This causes the display to have a substantial amount of underutilized space. Additionally, the above plastic jewelry display cards have been found to be relatively expensive and represent a significant cost factor when utilized for displaying low-priced jewelry items.

Therefore, it is an object of the present invention to provide a jewelry hanger at low cost and of sufficient strength to display items, such as, hoop earrings, in a natural hanging state so that the hoop earring may hang and not touch one another when being displayed. It is also another object to provide an earring hanger that may be displayed in any standard jewelry display case.

### SUMMARY OF THE DISCLOSED TECHNOLOGY

The subject invention provides novel and effective display card that overcomes many of the disadvantages of the available jewelry display cards. Specifically, the display cards of the subject invention are preferably manufactured from light cardboard, easily manufactured at a substantially reduced cost, relatively simple to assemble and may be displayed on a standard jewelry display case.

A jewelry hanger card may include a body, a neck, a jewelry holder and a pair of supports. The body, the jewelry holder and the pair of supports may be individually and foldably connected to the neck at respective fold lines. During assembly, each fold line is folded approximately 90 degrees with respect to the neck and a J-clip maybe adhered to a back surface of the body so that the jewelry hanger card may form a jewelry hanger for a display case. A pair of earring or any other item may then be secured to the display card and hung on a rack for display.

Specifically, a jewelry hanger card comprises a body, a neck, a jewelry holder, a pair of supports. The neck is foldably connected to the body at a first fold line, the jewelry holder is foldably connected to the neck at a second fold line and the supports are foldably connected to the neck at a third and fourth fold line.

To assemble the earring hanger card a fold is first made by folding the neck toward the body. A second fold is then made by folding one support toward the neck. A third fold is made by folding the other support toward the neck. Finally, a fourth fold is made by folding the jewelry holder toward the neck. After the folds are made, a J-clip may then be adhered to folded display card. In another embodiment, a J-type hanger device may be foldably incorporated into the body of the jewelry hanger card. Once fully assembled, the jewelry hanger card forms a jewelry hanger for a display case.

To display jewelry, for example, hoop earring, the hoop earrings are inserted into two apertures located near the ends of the earring holder. The weight of these earrings allows the earring holder and the neck to exert pressure onto the supports so that top portion of the assembled jewelry card may be held firmly in place. In other words, the pair of supports inhibits the neck from folding onto the body when a jewelry item is being displayed on the jewelry hanger card. Now, when the jewelry hanger is placed on a display, the earring may hang in a forward dangling position.

The hanger card may be manufactured by cutting and scoring a card so as to form a hanger card having a body, a neck, a holder and a support. After the manufacturing process, the body may be foldably connected to the neck at a first fold line, the holder may be foldably connected to the neck at a second fold line and the support may be foldably connected to the neck at a third fold line. The method of manufacturing may also include punching at least one hole in the holder and rounding corners and edges of the card for aesthetic purposes. It is also contemplated that perforations may be used to form some aspects of the hanger card, e.g., the top and bottom of the support sections may be perforated instead of being cut.

### BRIEF DESCRIPTION OF THE DRAWINGS

FIG. 1 is a top view of an unfolded earring hanger card;

FIGS. 2a-b show the assembly method for folding the earring hanger card;

FIG. 3 is a side view of an assembled earring hanger card;

FIG. 4 is a perspective view of an assembled earring hanger card;

FIG. 5 is a side view of an assembled earring hanger card;

FIG. 6 is a front view of an assembled earring hanger card with hoop earring; and

FIG. 7 is a side view of an assembled earring hanger card with hoop earring;

FIG. 8 is a perspective view of an assembled earring hanger cards hung on a J-channel of a display case; and

FIG. 9 shows common jewelry display cards being hung on a J-channel of a display case.

### DETAILED DESCRIPTION

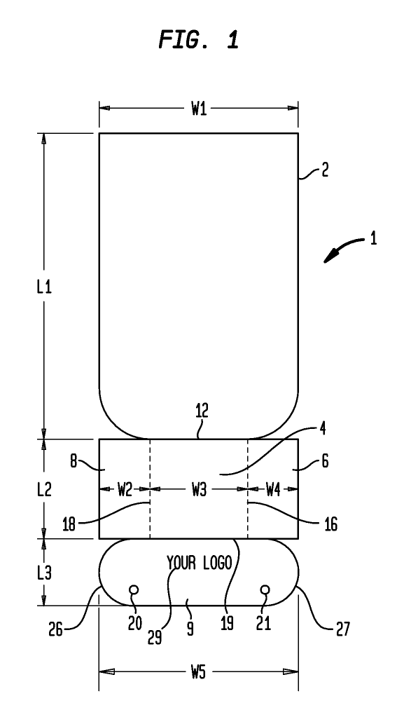

Referring now to the drawings, the jewelry display card of the subject invention is illustrated in FIGS. 1 through 8. The jewelry display card 1 may be used to hang any jewelry item such as earrings, pendants, brooches, necklaces, bracelets, etc. on a jewelry display case. The preferred embodiment, however, is for the display of earrings, in particular, hoop earrings on an earring display case.

FIG. 1 shows an unfolded earring hanger card 1. The earring hanger card 1 is manufactured from a unitary piece of material such as heavy weight paper, lightweight cardboard, plastic or any other material and may be shipped flat.

The earring hanger card 1 has a body 2, a neck portion 4, two supports 6, 8 and an earring holder 9. The body 2 is foldably connected to the neck portion 4 separated by fold line 12. The neck portion 4 is also foldably connected to two supports 6, 8 separated by fold lines 16, 18, respectively. The neck portion is also foldably connected to an earring holder 9 separated by fold line 19. The earring holder 9 may also include two apertures 20, 21 for receiving a display item, for example, a pair of earrings.

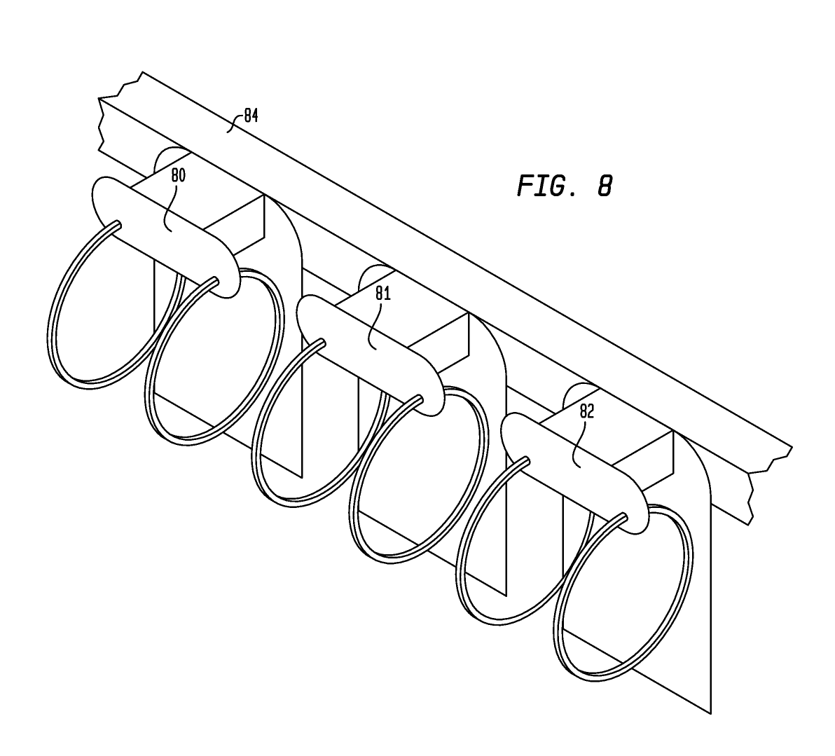

The length and width (L×W) of the unfolded card may be ½″-6″×½″-3″. In the preferred embodiment, the card is 3″×1.5″. (Sizes and distances may vary depending on the item to be displayed.) In the preferred embodiment, the width of the body W1, the width of the earring holder W5, and the combined width of the supports and neck (W2+W3+W4) may be equal. The length of the body L1 may be greater then the length of the supports and the neck L2 and the length of the earring holder L3. The width of the neck W3 may be greater than the width of the supports W2, W4. (Please note that when being used to display hoop earrings the height of the neck H2 should be slightly larger than the radius R1 of the hoop earring (e.g., see, FIG. 7)). The width of the supports W2, W4 are approximately equal or less than the length of the earring holder L3. These lengths and widths are related to the application needed for displaying a particular jewelry item. In the preferred embodiment, the earring display card will be used to display hoop earrings.

FIG. 1 also shows the shape of the earring holder 9. The earring holder 9 may have ends 26, 27 that are curved in shape but the end shape of the earring holder 9 is merely aesthetic and any shape may be used. Furthermore, the earring holder 9 may have a design logo imprinted on the front side of the earring holder 9.

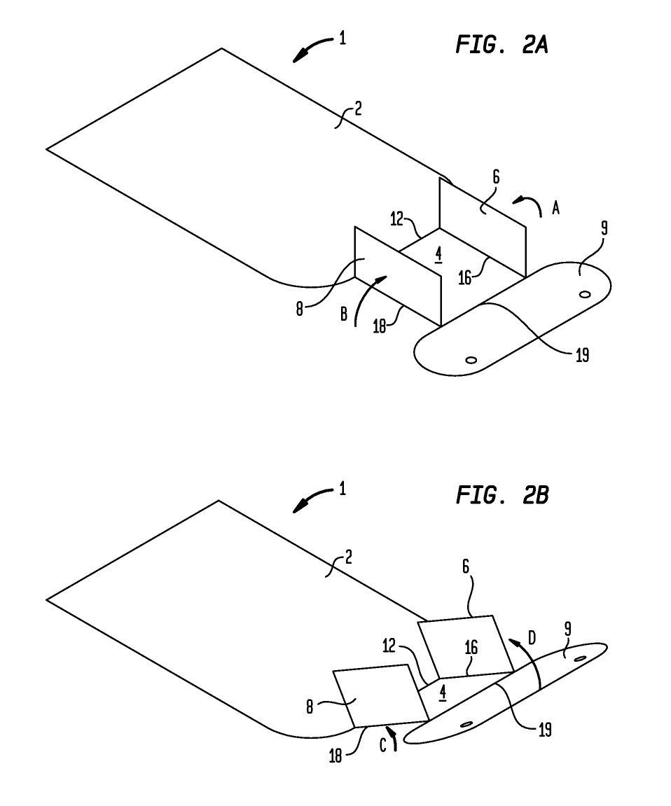

FIGS. 2a-b shows the assembly method for the earring hanger card. First, supports 6, 8 are folded along fold lines 16, 18, respectively towards neck 4 as shown by arrows A and B. It is preferred that the supports 6, 8 should be folded so an approximate 90 degree angle is formed at the fold lines 16, 18 with respect to neck 4. Second, the neck 4 is folded toward the body 2 along fold line 12 at a preferred approximate angle of 90 degree angle being formed at fold line 16 as shown by arrow C. Third, the earring holder 9 folded toward the neck 4 along fold line 19 as shown by arrow D so that a preferred approximate angle of 90 degrees is formed at fold line 20. The order of these operations are for illustrative purposes and the card may be folded using a different order.

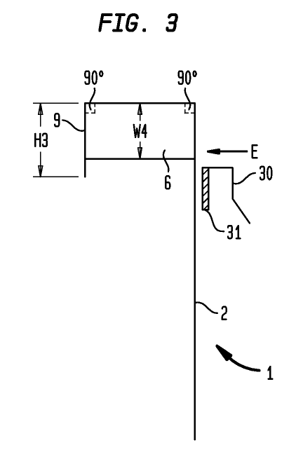

As shown in FIG. 3, after the jewelry card 1 is assembled a standard J-hook 30 may be adhered to the back of the card with an adhesive strip 31 as shown by arrow E. This hook 30 allows the jewelry card 1 to be mounted on a jewelry display case. Please note that the J-type hanger is for illustrative purposes only and any type of attachable hanger may be adhered to the back of the display card 1. It is also contemplated that a hanger device may be incorporated into the unitary construction by providing a fold out hook. The fold out hook may be folded out from the rear of the body of the card (not shown).

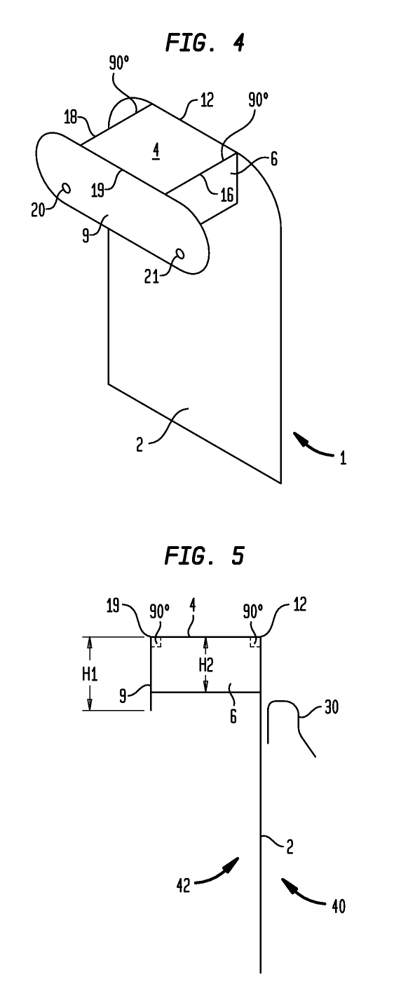

FIG. 4-5 show an assembled jewelry card 1. The assembled card 1 will have a back 40 that was formed by the body and a front 42 formed by an earring holder, neck and body. When assembled, the ends of the earring holder 9 extend in an outward direction past the supports 6, 8. This will allow earrings to hang away and be unobstructed by the neck portion when attached to the jewelry holder 9. As shown in FIG. 5 the height H1 of the earrings holder 9 is larger than the height H2 of the supports 6, 8. This difference in height hides the view of the supports 6, 8 when the display card 1 is being displayed. It should be noted that during assembly of the earring card if the folds do not make the desired angles once the weight of the jewelry items are exerted on the earring holder, the fold lines will in turn exert pressure on the supports. This force causes fold lines 12 and 19 to form angles the desired angles.

The angles formed at fold lines 16 and 18 are also preferably 90 degrees. But this is not critical to the invention. The angle formed at the supports 6, 8 must be of such size that the supports 6, 8 function as intended. That is, the supports 6, 8 must sustain the weight of the neck 4 and earring holder 9 when under the force of having earrings attached. It has been found that any angle between 45-135 degrees will suffice with 85-95 degrees being optimal.

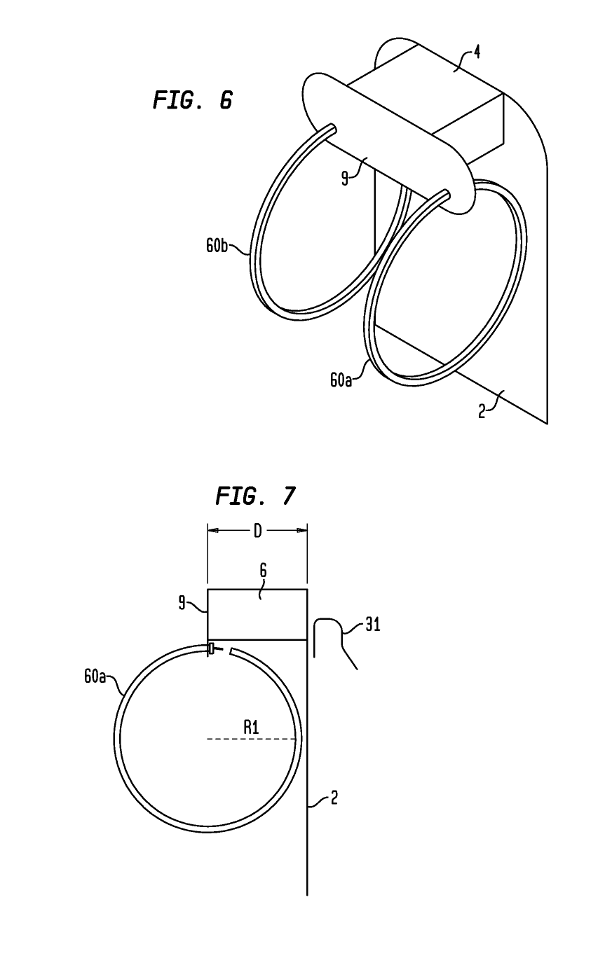

As shown in FIGS. 6 and 7, a pair of hoop earrings 60a-b may be inserted through apertures 20, 21 and the earrings 60a-b may be hung from the earring holder 9. The apertures may include an adhesive-backed strengthening strip (not shown) to enforce the perimeter of the aperture so that tearing of the aperture may be avoided when earrings are inserted into the openings.

Additionally, the neck should be of a depth D that is equal to or slightly larger than the radius of the hoop earring 60a-b. This will allow the earrings 60a-b to dangle from the earring holder 9 and make minimal to no contact with the body 2 of the earring hanger 1. The neck 4 is supported by supports 6, 8 so that, regardless of the weight of the earrings, 60a-b the neck will not fold by the pressure being exerted by the weight of the earrings 60a-b.

A main advantage of earring hanger 1 is that when the hoop earrings are dangled from the earring holder, the weight of the earrings do not cause the display hanger to bend because the supports will hold the earring holder and neck in an upright position. In order for the display card to function properly, the material of the card must be of a sufficient strength so that the supports can support the weight of the earrings and not be crushed under the weight. Also, the material of the card must be of a sufficient strength so that earrings, when inserted through the apertures 12a-b do not pull or tear through the apertures 20, 21.

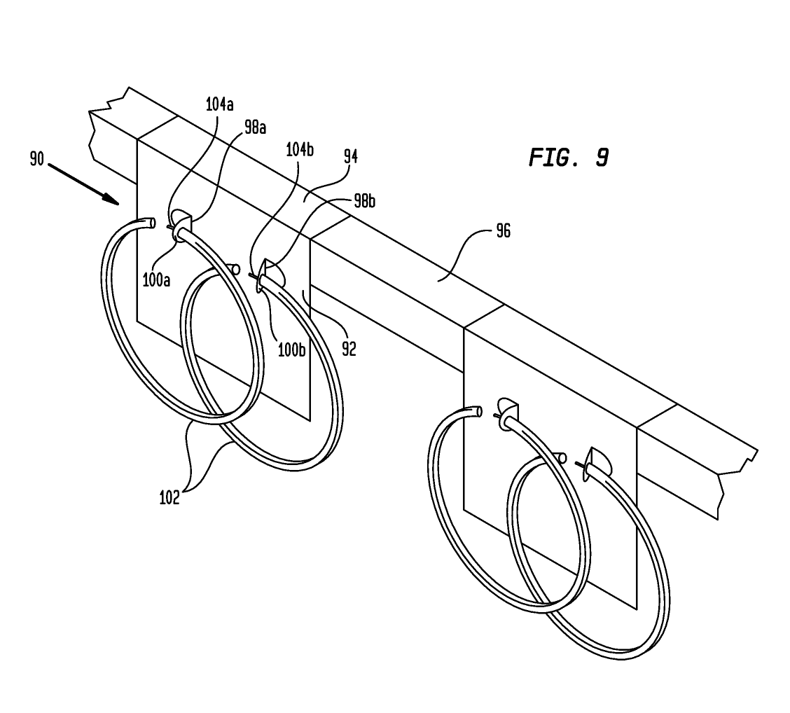

FIG. 8 shows a group of display hangers 80-82 suspended from a J-channel 84. The J-channel 84 is for illustrative purposes only as any type of hanger device may be attached to the rear of the display cards 80-82. In use, the earring hanger cards allows a customer to view the front design of earrings because the earring hanger allows earrings to hang forward instead of flat (as in previous hanger designs) and keeps earring floating. This allows a customer to better imagine how the earrings will look when dangled from an ear. The earring hanger cards 80-82 also allow the earrings to hang forward and away from one another so that when displayed the earrings will not scratch each other and/or the earrings will not interfere with the display of adjacent display cards. The earring hangers 80-82 are also more slender than the traditional cards and allow more earrings to be displayed in the same amount of space. Furthermore, the jewelry hanger can be provided for low cost and of sufficient strength to display items, such as, hoop earring, in a natural hanging state.

Further, the hanger card may be manufactured by cutting and scoring a card so as to form a hanger card having a body, a neck, a holder and a support. After the manufacturing process, the body may be foldably connected to the neck at a first fold line, the holder may be foldably connected to the neck at a second fold line and the support may be foldably connected to the neck at a third fold line. The method of manufacturing may also include punching at least one hole in the holder and rounding corners and edges of the card for aesthetic purposes. It is also contemplated that perforations may be used to form some aspects of the hanger card, e.g., the top and bottom of the support sections may be perforated instead of being cut.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A hanger card comprising:
a body;
a neck, the neck having a first fold line, a second fold line and a third fold line located on a perimeter of the neck, the neck being foldably connected to the body at a the first fold line;
a holder, the holder being foldably connected to the neck at a the second fold line;
a support, the support being foldably connected to the neck at the third fold line; and
wherein the hanger card is folded so that the neck is folded at the first fold line with respect to the body, the holder is folded at the second fold line with respect to the neck and the support is folded at the third fold line with respect to the neck thereby allowing the support to inhibit the neck from folding onto the body.

2. The hanger card of claim 1 further comprising:
a second support, the second support being foldably connected to the neck at a fourth fold line

3. The hanger card of claim 1 wherein the hanger card is manufactured from a lightweight cardboard.

4. The hanger card of claim 1 further comprising: a hook adhered to a back of the body.

5. The hanger card of claim 1 further comprising: a fold out hook foldably incorporated into the body of the hanger card.

6. The hanger card of claim 1 wherein the holder includes at least one aperture for displaying jewelry.

7. The hanger card of claim 2 wherein the supports inhibit the neck from folding onto the body when a jewelry item is being displayed on the hanger card.

8. The hanger card of claim 7 wherein the jewelry item is a pair of hoop earrings.

9. The hanger card of claim 8 wherein the earrings are displayed in a forward dangling position.

10. The hanger card of claim 9 wherein a depth of the neck is greater than a radius of the hoop earrings.

11. The hanger card of claim 1 wherein a height of the holder is greater than the a height of the supports.

12. The method of assembling an earring hanger card to form an earring hanger comprising the steps of:
folding a neck toward a body at a first fold line;
folding a first support toward the neck at a second fold line;
folding a second support toward the neck at a third fold line;
folding an earring holder toward the neck at a fourth fold line;
inserting at least two earring into at least two apertures located on the earring holder; and
hanging earrings from the earring holders, wherein the weight of the earring allows the first support and the second support to hold the neck firmly in place so that the earring may be displayed in a forward dangling position.

13. The method of claim 12 further comprising the step of:
adhering a hanger to a rear side of the body.

14. The method of claim 12 further comprising the step of:
hanging the earring hanger card from a display case.

15. The method of claim 12 wherein a depth of the neck is greater than a radius of the hoop earrings.

16. The method of claim 12 wherein a height of the earring holder is greater than a height of the supports.

17. A method of manufacturing a hanger card comprising the steps of:
cutting and scoring a card so as to form a hanger card having a body, a neck, a holder and at least one support.

18. The method of manufacturing a hanger card as claimed in claim 17 wherein the body is foldably connected to the neck at a first fold line, the holder is foldably connected to the neck at a second fold line; and the at least one support is foldably connected to the neck at a third fold line.

19. The method of manufacturing a hanger card as claimed in claim 17 further comprising the step of:
punching at least one hole in the holder.

20. The method of manufacturing a hanger card as claimed in claim 17 further comprising the step of:
rounding corners and edges of the card.
